(19) United States
(12) Patent Application Publication
(10) Pub. No.: US 2025/0269858 A1
(43) Pub. Date: Aug. 28, 2025

(54) TRAINING METHOD FOR DETERMINING DRIVING ROUTE OF VEHICLE AND APPARATUS FOR PERFORMING THE SAME

(71) Applicant: 42dot Inc., Seoul (KR)

(72) Inventor: Dong Chan KIM, Seongnam-si (KR)

(21) Appl. No.: 18/955,531

(22) Filed: Nov. 21, 2024

(30) Foreign Application Priority Data
Feb. 27, 2024 (KR) 10-2024-0027925

(51) Int. Cl. B60W 50/00; B60W 60/00; G01C 21/34

(52) U.S. Cl. CPC B60W 50/00; B60W 60/00272; G01C 21/3446; B60W 2050/0083

(57) ABSTRACT

Provided is a training method for determining a driving route of a vehicle. The training method includes extracting a latent vector based on trajectories corresponding to maneuver modes that a vehicle is capable of selecting in a driving situation and training a model for generating route distributions to determine a driving route of the vehicle, based on a driving dataset and the latent vector, in which the trajectories are generated by applying, to a route search algorithm, weights of indicators for maneuvers differently according to the maneuver modes.

### CROSS-REFERENCE TO RELATED APPLICATIONS

This application claims the benefit of Korean Patent Application No. 10-2024-0027925, filed on Feb. 27, 2024, in the Korean Intellectual Property Office, the entire disclosure of which is incorporated herein by reference for all purposes.

### BACKGROUND

### 1. Field of the Invention

One or more embodiments relate to a training method for determining a driving route of a vehicle and an apparatus for performing the same.

### 2. Description of the Related Art

Route planning may be technology for generating a route for a vehicle to drive. When there are obstacles around a vehicle, a route that the vehicle may select in relation to the obstacles may vary. For example, when there is another vehicle at the front, a vehicle may select a route to avoid the other vehicle to the left side or right side, stop, or overtake the other vehicle. The determining of a driving route by considering all routes that a vehicle may select may require a large amount of computation. Technology to efficiently generate a driving route of a vehicle while considering various routes that the vehicle may select may be required.

The above description has been possessed or acquired by the inventor(s) in the course of conceiving the present disclosure and is not necessarily an art publicly known before the present application is filed.

### SUMMARY

Embodiments provide a vehicle that may generate trajectories according to maneuver modes that the vehicle may select in a driving situation.

Embodiments provide a technique for efficiently training a model using generated trajectories.

Embodiments provide a technique for controlling the driving of a vehicle using a route distribution generation model with improved performance.

However, the technical aspects are not limited to the aforementioned aspects, and other technical aspects may be present.

According to an aspect, there is provided a method of determining a driving route of a vehicle, the method including extracting a latent vector based on trajectories corresponding to maneuver modes that the vehicle is capable of selecting in a driving situation and training a model for generating route distributions to determine the driving route of the vehicle, based on a driving dataset and the latent vector.

The trajectories may be generated by applying, to a route search algorithm, weights of indicators for maneuvers differently according to the maneuver modes.

The indicators may include a first indicator for a search time, a second indicator for a reference velocity, a third indicator for a lateral movement, a fourth indicator for a longitudinal movement, and a fifth indicator for a heading angle.

The driving dataset may include a velocity of the vehicle, map information, and occupancy information of obstacles around the vehicle.

The maneuver modes may include a first maneuver mode for keeping a lane, a second maneuver mode for changing a lane, a third maneuver mode for stopping the vehicle, a fourth maneuver mode for swerving from obstacles around the vehicle, and a fifth maneuver mode for following trajectories of the obstacles around the vehicle.

The trajectories may be generated by applying, to the route search algorithm, an operating range corresponding to each of the maneuver modes.

The operating range may include an operating range for at least one of a steering angle and a longitudinal acceleration.

The weights may be determined based on one or more of the maneuver modes and information about the driving situation.

The information about the driving situation may include lane information and information about obstacles around the vehicle.

The route search algorithm may include a hybrid A* algorithm.

The method may further include obtaining a route distribution by inputting the driving dataset to the trained model and controlling driving of the vehicle based on the route distribution.

According to another aspect, there is provided an apparatus for determining a driving route of a vehicle, the apparatus including a memory configured to store instructions and a processor electrically connected to the memory and configured to execute the instructions, in which, when the instructions are executed by the processor, the processor is configured to control a plurality of operations, and the plurality of operations includes extracting a latent vector based on trajectories corresponding to maneuver modes that the vehicle is capable of selecting in a driving situation and training a model for generating route distributions to determine the driving route of the vehicle, based on a driving dataset and the latent vector.

The trajectories may be generated by applying, to a route search algorithm, weights of indicators for maneuvers differently according to the maneuver modes.

The indicators may include a first indicator for a search time, a second indicator for a reference velocity, a third indicator for a lateral movement, a fourth indicator for a longitudinal movement, and a fifth indicator for a heading angle.

The driving dataset may include a velocity of the vehicle, map information, and occupancy information of obstacles around the vehicle.

The maneuver modes may include a first maneuver mode for keeping a lane, a second maneuver mode for changing a lane, a third maneuver mode for stopping the vehicle, a fourth maneuver mode for swerving from obstacles around the vehicle, and a fifth maneuver mode for following trajectories of the obstacles around the vehicle.

The trajectories may be generated by applying, to the route search algorithm, an operating range corresponding to each of the maneuver modes.

The operating range may include an operating range for at least one of a steering angle and a longitudinal acceleration.

The weights may be determined based on one or more of the maneuver modes and information about the driving situation.

The information about the driving situation may include lane information and information about obstacles around the vehicle.

The route search algorithm may include a hybrid A* algorithm.

The plurality of operations may further include obtaining a route distribution by inputting the driving dataset to the trained model and controlling driving of the vehicle based on the route distribution.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an autonomous driving method according to an embodiment;

FIG. 2 is a block diagram illustrating hardware included in an autonomous driving apparatus, according to an embodiment;

FIG. 3 is a block diagram illustrating a vehicle control system according to an embodiment;

FIG. 4 is a diagram illustrating a coordinate system used for generating trajectories, according to an embodiment;

FIG. 5 is a diagram illustrating an example of generated trajectories, according to an embodiment;

FIG. 6A is a diagram illustrating training a model that generates a route distribution, according to an embodiment;

FIG. 6B is a diagram illustrating generating a route distribution using a trained model, according to an embodiment;

FIGS. 7A to 7C are diagrams illustrating generated route distributions, according to an embodiment;

FIG. 8 is a flowchart illustrating a method of determining a driving route of a vehicle, according to an embodiment; and

FIG. 9 is a schematic block diagram illustrating an electronic device according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, or similarly, the second component may be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

As used in connection with the present disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

The term “unit” used herein may refer to a software or hardware component, such as a field-programmable gate array (FPGA) or an ASIC, and the “unit” performs predefined functions. However, the term “unit” is not limited to software or hardware. A “unit” may be configured to be in an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, embodiments will be described in detail with reference to the accompanying drawings. When describing the embodiments with reference to the accompanying drawings, like reference numerals refer to like elements and a repeated description related thereto will be omitted.

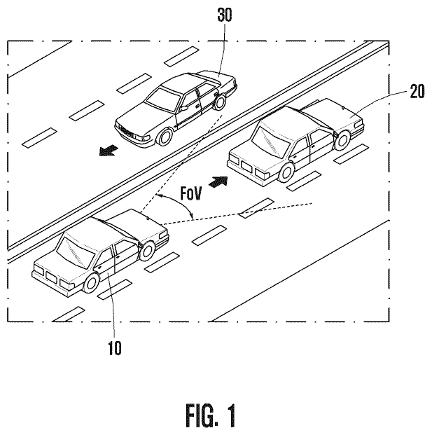

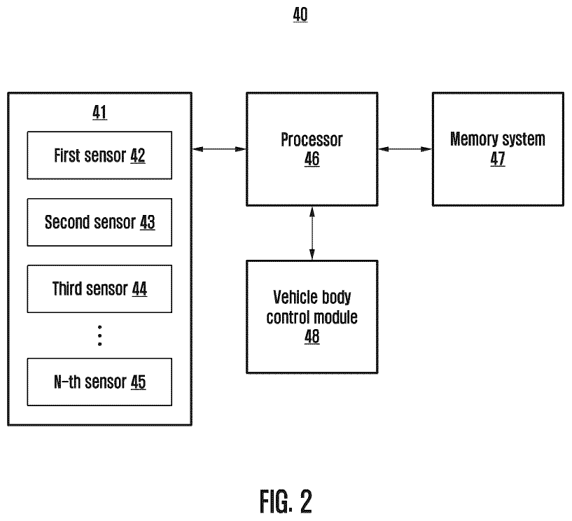

FIG. 1 is a diagram illustrating an autonomous driving method according to an embodiment, and FIG. 2 is a block diagram illustrating hardware included in an autonomous driving apparatus, according to an embodiment.

Referring to FIG. 1, according to an embodiment, an autonomous driving apparatus (e.g., an autonomous driving apparatus 40 of FIG. 2) may be mounted on a vehicle and implement an autonomous vehicle 10. The autonomous vehicle 10 may be a car that may drive on its own without an operation of a driver.

The autonomous driving apparatus 40 mounted on the autonomous vehicle 10 may include various sensors (e.g., a sensor unit 41 of FIG. 2) to collect pieces of information about a surrounding situation.

The autonomous driving apparatus 40 may detect the movement of a preceding vehicle 20 driving at the front through an image sensor and/or an event sensor mounted on the front surface of the autonomous vehicle 10. The autonomous driving apparatus 40 may further include sensors to detect other vehicles 30 driving on the next lane and pedestrians around the autonomous vehicle 10 in addition to the front of the autonomous vehicle 10.

At least one of the sensors to collect pieces of situation information around the autonomous vehicle 10 may have a predetermined field of view (FoV), as shown in FIG. 1. When a sensor mounted on the front surface of the autonomous vehicle 10 has an FoV, as shown in FIG. 1, information detected from the center of the sensor may have relatively high importance. This may be because most of the information detected from the center of the sensor includes information corresponding to the movement of the preceding vehicle 20.

The autonomous driving apparatus 40 may process pieces of information collected by the sensors of the autonomous vehicle 10 in real time and control the movement of the autonomous vehicle 10, and at least some of the pieces of information collected by the sensors may be stored in a memory device (e.g., a memory system 47 of FIG. 2).

Referring to FIG. 2, according to an embodiment, the autonomous driving apparatus 40 may include the sensor unit 41, a processor 46, the memory system 47, and a vehicle body control module 48.

The sensor unit 41 may include a plurality of sensors 42 to 45. The sensors 42 to 45 may include an image sensor, an event sensor, an illuminance sensor, a global positioning system (GPS) device, an acceleration sensor, and the like. Pieces of data collected by the sensors 42 to 45 may be transmitted to the processor 46.

The processor 46 may store the pieces of data collected by the sensors 42 to 45 in the memory system 47. The processor 46 may control the vehicle body control module 48 based on the pieces of data collected by the sensors 42 to 45 and determine the movement of a vehicle.

The memory system 47 may include two or more memory devices and a system controller to control the memory devices. Each of the memory devices may be provided as a single semiconductor chip. In addition to the system controller of the memory system 47, each of the memory devices included in the memory system 47 may include a memory controller. The memory controller may include an artificial intelligence (AI) operation circuit such as a neural network. The memory controller may generate operation data by assigning predetermined weights to the pieces of data received from the sensors 42 to 45 or the processor 46 and store the operation data in a memory chip.

The vehicle body control module 48 may receive instructions from the processor 46 and control the movement of the vehicle.

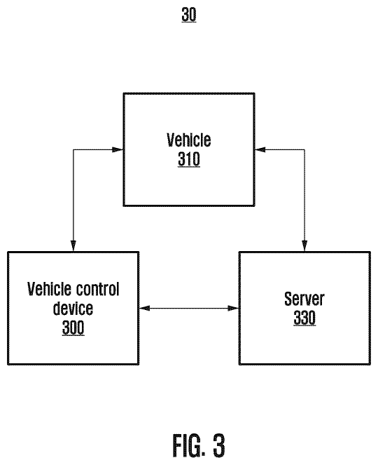

FIG. 3 is a block diagram illustrating a vehicle control system according to an embodiment.

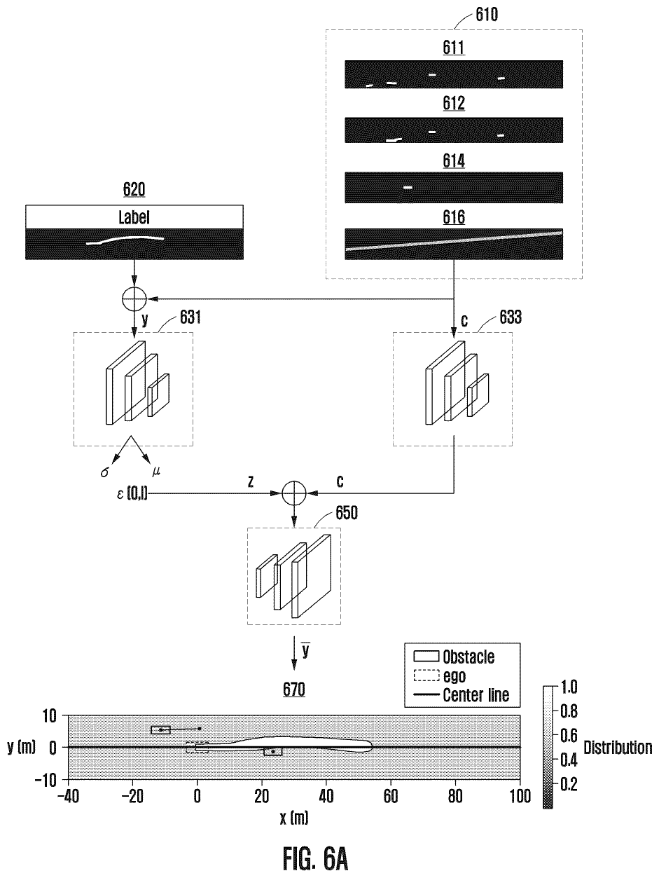

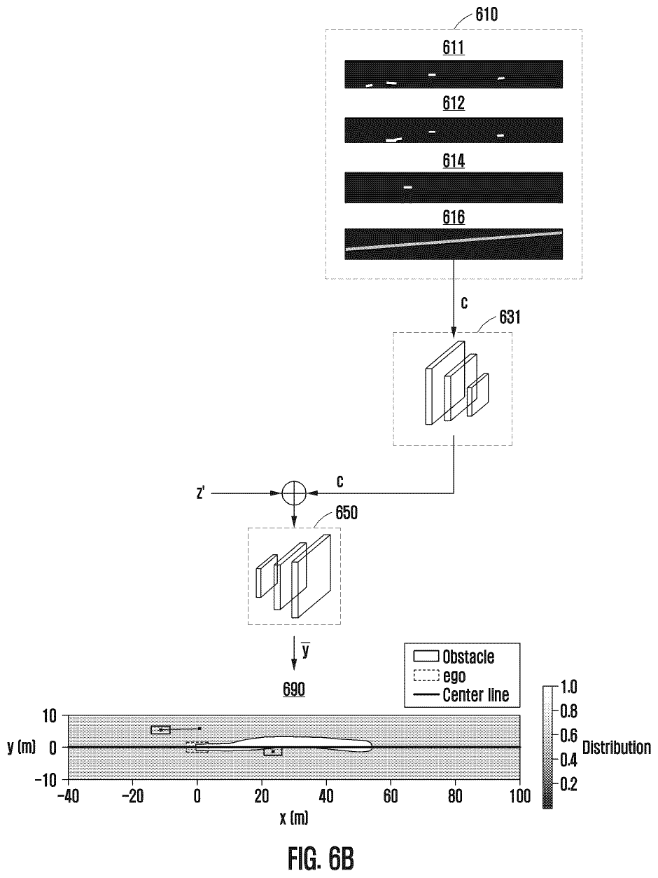

Referring to FIG. 3, according to an embodiment, a vehicle control system 30 may include a vehicle 310, a vehicle control device 300, and a server 330. The vehicle control device 300 may include a device for controlling a vehicle (e.g., the vehicle 310). The vehicle control device 300 may be implemented in the server 330 or implemented as a separate device from the server 330. The vehicle control device 300 may control the driving of the vehicle 310. The vehicle 310 refers to a vehicle capable of transporting objects and/or people and may include, for example, a vehicle such as a car, a train, a ship, a boat, an aircraft, a kickboard, and/or a bicycle. The vehicle 310 may be the autonomous driving apparatus 40 of FIG. 1. The vehicle control device 300 may control the driving of the vehicle 310 based on a route distribution. The route distribution may be a distribution of routes that the vehicle 310 may drive. The route distribution may be used as an input of a planning algorithm for autonomous driving. The vehicle control device 300 may input a driving dataset to a trained model and obtain the route distribution. The trained model is a model (hereinafter, referred to as a route distribution generation model) for generating the route distribution to determine a driving route of the vehicle 310 and may include a model generated by the vehicle control device 300 and a model generated by an external server (not shown). The trained model may be trained by the vehicle control device 300. The training of the model by the vehicle control device 300 is described in detail below with reference to FIG. 6A.

According to an embodiment, each component entity (e.g., the vehicle control device 300, the vehicle 310, and the server 330) of the vehicle control system 30 may perform communication using a network (not shown). For example, the network may include a local area network (LAN), a wide area network (WAN), a value-added network (VAN), a mobile radio communication network, a satellite communication network, and a combination thereof. The network is a comprehensive data communication network that allows each component entity (e.g., the vehicle control device 300, the vehicle 310, and the server 330) to communicate smoothly with each other and may include wired Internet, wireless Internet, and a mobile wireless communication network. Additionally, a wireless communication network may include, but is not limited thereto, a wireless LAN (wireless fidelity (Wi-Fi)), Bluetooth, Bluetooth low energy, Zigbee, Wi-Fi Direct (WFD), ultra-wideband (UWB), infrared communication (infrared data association (IrDA)), near field communication (NFC), etc.

According to an embodiment, the vehicle control device 300 may extract a latent vector based on trajectories corresponding to maneuver modes that the vehicle 310 may select in a driving situation. The maneuver modes that the vehicle 310 may select in the driving situation may include various maneuver modes that the vehicle 310 may select to avoid collisions with obstacles (e.g., obstacles around the vehicle 310). The maneuver modes may include a first maneuver mode for keeping a lane, a second maneuver mode for changing a lane, a third maneuver mode for stopping the vehicle 310, a fourth maneuver mode for swerving from obstacles, and a fifth maneuver mode for following trajectories of the obstacles. However, the first to fifth maneuver modes are embodiments, and the maneuver modes that the vehicle 310 may select are not limited thereto.

According to an embodiment, the vehicle control device 300 may generate the trajectories by applying, to a route search algorithm, weights of indicators (e.g., heuristic costs) for maneuvers differently according to the maneuver modes. The route search algorithm may include a hybrid A* algorithm. The trajectories may include pseudo ground truth (GT) data that the vehicle control device 300 uses to train the model (e.g., the route distribution generation model). The vehicle control device 300 may train the route distribution generation model based on the driving dataset and the latent vector. The driving dataset may include the velocity of the vehicle 310, map information, and occupancy information of the obstacles around the vehicle 310. The vehicle control device 300 may obtain, from the vehicle 310, the driving dataset and/or information about the driving situation of the vehicle 310. For example, the vehicle control device 300 may obtain the driving dataset and/or the information about the driving situation of the vehicle 310, based on information about the surrounding environment of the vehicle 310 detected by the vehicle 310 using a camera sensor, a radio detection and ranging (RADAR) sensor, and/or a light detection and ranging (LiDAR) sensor. The information about the driving situation may include lane information and information about the obstacles around the vehicle 310.

In an embodiment, the route distribution may be used to determine the driving route of the vehicle 310. The driving route of the vehicle 310 may be determined by a planning algorithm. The planning algorithm may include an algorithm for planning a safe and efficient driving route for the vehicle 310 to reach a destination. For example, the planning algorithm may include an algorithm for planning the driving route of the vehicle 310 based on the route distribution. The planning algorithm may include a sampling-based planning algorithm and an optimization-based planning algorithm. The planning algorithm may include an algorithm for planning the driving route of the vehicle 310 such as longitudinal (e.g., forward and backward) driving planning, lane changing, and yield decision. Forward and backward driving planning may include driving planning for the longitudinal movement of the vehicle 310. The vehicle control device 300 may determine the driving route of the vehicle 310 based on the route distribution and the planning algorithm. The vehicle 310 may drive autonomously based on the driving route. For example, a processor (e.g., the processor 46 of FIG. 2) and/or the vehicle control device 300 may control a vehicle body control module (e.g., the vehicle body control module 48) according to the determined driving route and determine the movement of the vehicle 310.

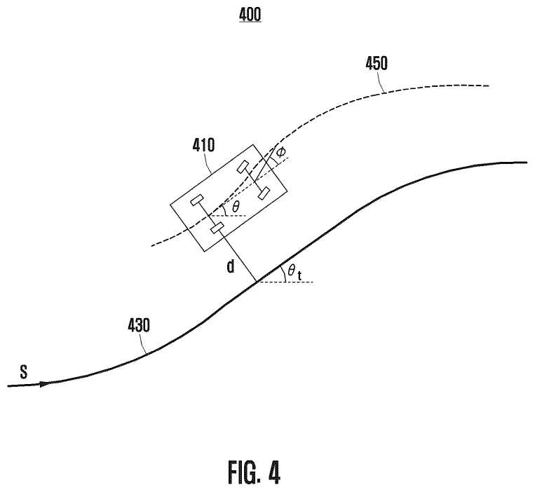

FIG. 4 is a diagram illustrating a coordinate system used for generating trajectories, according to an embodiment.

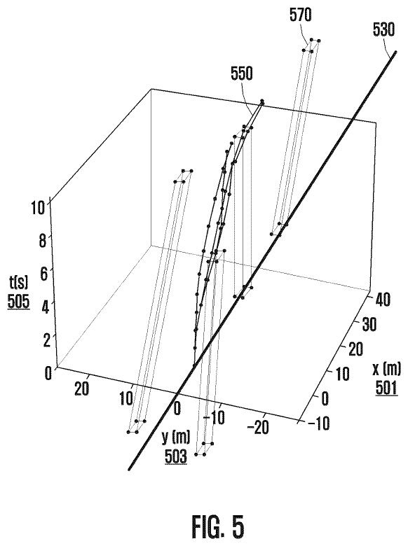

Referring to FIG. 4, according to an embodiment, a vehicle control device (e.g., the vehicle control device 300 of FIG. 3) may generate trajectories using a route search algorithm on a coordinate system 400. The coordinate system 400 may include a Frenet frame. The Frenet frame is a coordinate system that may be used to geometrically describe a curve and may be useful for describing the position and direction of travel of a vehicle (e.g., a vehicle 410) (e.g., the vehicle 310 of FIG. 3). The coordinate system 400 may include an s domain to represent a distance that the vehicle 410 travels in the longitudinal direction along a driving trajectory 450, a d domain to represent a distance that the vehicle 410 is away from a centerline 430 in the lateral direction, and a t domain for time. The vehicle control device 300 may generate the trajectories (e.g., pseudo-GT data) based on the coordinate system 400. For example, the vehicle control device 300 may generate pseudo GT data using a kinematic bicycle model as a transition model on the coordinate system 400. The kinematic bicycle model is a model used to simulate the movement of the vehicle 410 and may also be a model simplified to have two wheels of the vehicle 410. The vehicle control device 300 may easily generate the trajectories using the route search algorithm on the coordinate system 400. The generated trajectories may be expressed in a three-dimensional (3D) space. The trajectories generated by the vehicle control device 300 are described in detail below with reference to FIG. 5.

FIG. 5 is a diagram illustrating an example of generated trajectories, according to an embodiment.

Referring to FIG. 5, according to an embodiment, a vehicle control device (e.g., the vehicle control device 300 of FIG. 3) may generate a trajectory 550 (e.g., pseudo-GT data) in a 3D space represented by an x-axis 501, a y-axis 503, and a t-axis 505 for time. The trajectory 550 may be one of the trajectories corresponding to maneuver modes that a vehicle (e.g., the vehicle 310) may select in a driving situation. The trajectory 550 may include a trajectory that the vehicle 310 drives for a certain time (e.g., n seconds). The vehicle control device 300 may generate the trajectory 550 using a route search algorithm (e.g., a hybrid A* algorithm). The hybrid A* algorithm is a route search algorithm based on an A* algorithm and may be an algorithm for finding an optimal route that is kinematically feasible without collision from a starting point to an arrival point. Unlike the A* algorithm, the hybrid A* algorithm may have a high calculation speed by considering the movement constraints of the vehicle 310 and using a heuristic cost. The vehicle control device 300 may generate trajectories (e.g., the trajectory 550) by applying, to the route search algorithm, weights of indicators (e.g., heuristic costs) for maneuvers differently according to the maneuver modes. The indicators for the maneuvers may include a first indicator for a search time, a second indicator for a reference velocity, a third indicator for a lateral movement, a fourth indicator for a longitudinal movement, and a fifth indicator for a heading angle. The first indicator for a search time is an indicator for a time (e.g., n seconds) for searching for a trajectory through the route search algorithm and may be associated with the search speed. The second indicator for a reference velocity may be an indicator for a reference velocity (e.g., a speed limit of a road on which a vehicle is driving) for a driving situation of the vehicle 310. The third indicator for a lateral movement may be an indicator for the lateral movement of the vehicle 310. The fourth indicator for a longitudinal movement may be an indicator for a distance that the vehicle 310 may travel in the longitudinal direction. The fifth indicator for a heading angle may be an indicator for making the heading angle of the vehicle 310 ‘0’ to prevent the vehicle 310 from tilting to the left side or right side.

According to an embodiment, the vehicle control device 300 may determine a weight to be applied to each indicator, based on one or more of the maneuver modes and information about the driving situation. The information about the driving situation may include information about a lane (e.g., a lane 530) and information about an obstacle (e.g., an obstacle 570) around the vehicle. For example, the vehicle control device 300 may determine the weight differently according to the maneuver modes and may also determine the weight differently for the same maneuver mode according to the information about a lane and/or the information about an obstacle. The vehicle control device 300 may generate a trajectory (e.g., the trajectory 550) that is suitable for each maneuver mode and the driving situation by determining the weight to be applied to each indicator, based on one or more of the maneuver modes and the information about the driving situation. The trajectory 550 may then be used to train a model for generating route distributions to determine a driving route of the vehicle. The training of the model and the generating (e.g., inferring) of the route distributions to determine the driving route of the vehicle are described in detail below with reference to FIGS. 6A and 6B.

According to an embodiment, the vehicle control device 300 may input the information about a lane (e.g., the lane 530) and the information about an obstacle (e.g., the obstacle 570) to the route search algorithm (e.g., the hybrid A* algorithm) and generate the trajectory 550. The information about the lane 530 may include information such as the position of the lane 530, the number of lanes 530, the width of the lane 530, and the type of the lane 530. The information about the obstacle 570 may include information such as the position of the obstacle (e.g., an x coordinate, a y coordinate, and a heading angle), the width of the obstacle, the height of the obstacle, and the velocity of the obstacle.

According to an embodiment, the vehicle control device 300 may apply, to the route search algorithm, an operating range (e.g., a control action) corresponding to each of the maneuver modes. The operating range may include an operating range for at least one of a steering angle and a longitudinal acceleration. The operating range may be set differently according to the maneuver modes. For example, among the maneuver modes, since the fourth maneuver mode for swerving from an obstacle around the vehicle 310 is necessary to turn the travel direction to the left side or right side to swerve from the obstacle, the operating range for the steering angle may be set to be the widest. In another example, since the second maneuver mode for changing a lane is necessary to increase the velocity while changing a lane, the operating range for the longitudinal acceleration (e.g., the maximum acceleration) may be wider than that of other maneuver modes.

According to an embodiment, the operating range for the steering angle may include the maximum angle, the minimum angle, and an operating angle interval. The minimum angle may be a value that has the same absolute value as the maximum angle but has a different sign. For example, the operating range for the steering angle may be set to a range from the maximum angle of 40 degrees (°) to the minimum angle of −40° by 5° intervals and applied to the route search algorithm. Even when the operating range for the steering angle is set based on the same minimum angle and maximum angle, the trajectories to be generated when the operating range is set from the minimum angle (e.g., −40°) to the maximum angle (e.g., 40°) and when the operating range is set from the maximum angle (e.g., 40°) to the minimum angle (e.g., −40°) may be different. The operating range for the longitudinal acceleration may include the maximum acceleration, the minimum acceleration, and an operating acceleration interval. The minimum acceleration may be a value that has the same absolute value as the maximum acceleration but has a different sign. Even when the operating range for the longitudinal acceleration is set based on the same minimum acceleration and maximum acceleration, the trajectories to be generated when the operating range is set from the minimum acceleration to the maximum acceleration and when the operating range is set from the maximum acceleration to the minimum acceleration may be different.

FIG. 6A is a diagram illustrating training a model that generates a route distribution, according to an embodiment.

Referring to FIG. 6A, according to an embodiment, a vehicle control device (e.g., the vehicle control device 300 of FIG. 3) may train a model. The model may be a model for generating route distributions to determine a driving route of a vehicle. The model may include an autoencoder (e.g., a conditional variational autoencoder (CVAE)). The vehicle control device 300 may extract a latent vector z based on trajectories (e.g., the trajectory 550 of FIG. 5) corresponding to maneuver modes that the vehicle may select in a driving situation. The vehicle control device 300 may rasterize the trajectories and generate label data 620. The vehicle control device 300 may extract the latent vector z from the label data 620 using an encoder 631. The vehicle control device 300 may train the model (e.g., the CVAE) based on a driving dataset 610 and the latent vector z. The driving dataset 610 may include a velocity 614 of the vehicle, map information 616, and pieces of occupancy information 611 and 612 of an obstacle around the vehicle. The map information 616 may include information about a rasterized centerline. The pieces of occupancy information 611 and 612 are pieces of occupancy information of a rasterized obstacle expressed in an occupancy grid on a bird's eye view (BEV) and may include occupancy information of the obstacle according to elapsed time. For example, the occupancy information 611 may include occupancy information when t (time) is 0s (i.e., t (time)=0s) and the occupancy information 612 may include occupancy information when tis 2s (i.e., t=2s).

According to an embodiment, the vehicle control device 300 may encode the driving dataset 610 using an encoder 633. The vehicle control device 300 may sum the latent vector z and an encoded driving dataset c and input the summation result to a decoder 650. The decoder 650 may output a route distribution 670 based on the latent vector z and the driving dataset 610. The route distribution 670 may be a distribution of routes that the vehicle may select in a driving situation. The route distribution 670 may be one of the route distributions corresponding to the maneuver modes. The model may be trained to reduce the difference (e.g., loss) between the route distribution 670 and the label data 620. For example, the vehicle control device 300 may train the model to reduce Kullback-Leibler (KL) divergence loss between the label data 620 and the route distribution 670. The KL divergence loss may be cross entropy, which is the difference between two probability distributions.

FIG. 6B is a diagram illustrating generating a route distribution using a trained model, according to an embodiment.

Referring to FIG. 6B, the vehicle control device 300 may input the driving dataset 610 to the trained model and generate a route distribution 690. The encoder 631 and the decoder 650 may be models trained by the training method described above with reference to FIG. 6A. The vehicle control device 300 may input the driving dataset 610 to the encoder 631 and obtain an encoded driving dataset. The vehicle control device 300 may sum an arbitrary vector z′ and the encoded driving dataset and input the summation result to the decoder 650. The arbitrary vector z′ may be a vector that is randomly extracted from a distribution obtained based on the label data 620. The decoder 650 may generate the route distribution 690. The vehicle control device 300 may control the driving of a vehicle based on the route distribution 690. The vehicle control device 300 may determine the driving route of the vehicle based on the route distribution 690. The vehicle control device 300 may control the driving of the vehicle according to the determined driving route. The route distribution 690 may be one of the route distributions corresponding to the maneuver modes. The vehicle control device 300 may determine the driving route that the vehicle may select in a driving situation, based on the route distributions. For example, the vehicle control device 300 may determine, to be the driving route of the vehicle, a route having the highest distribution among the route distributions corresponding to the maneuver modes that the vehicle may select in the driving situation. The vehicle 310 may autonomously drive based on the driving route. For example, a processor (e.g., the processor 46 of FIG. 1) and/or the vehicle control device 300 may control a vehicle body control module (e.g., the vehicle body control module 48) according to the determined driving route and determine the movement of the vehicle 310.

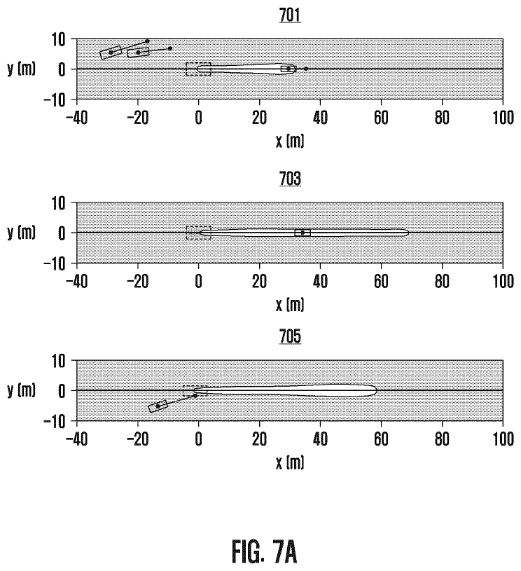

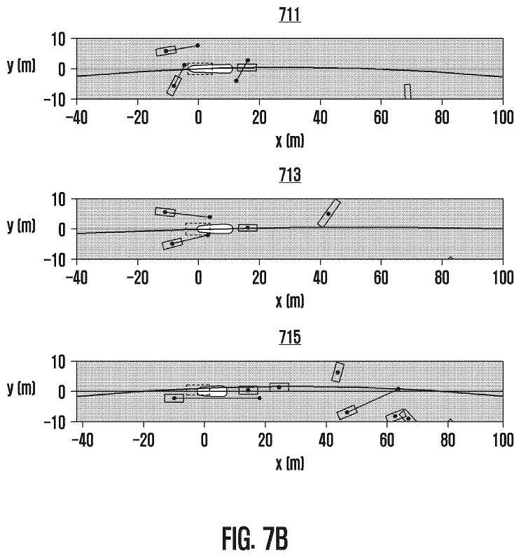

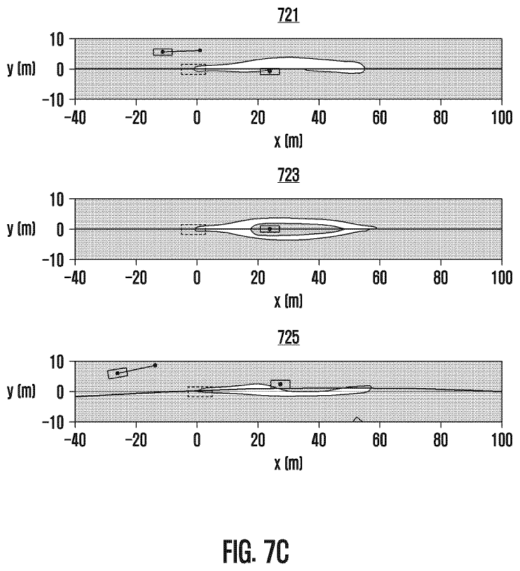

FIGS. 7A to 7C are diagrams illustrating generated route distributions, according to an embodiment.

Referring to FIGS. 7A to 7C, according to an embodiment, route distributions 701, 703, and 705 may be route distributions corresponding to a first maneuver mode for keeping a lane and a fifth maneuver mode for following trajectories of obstacles around a vehicle. The route distributions 701 and 703 may be distributions of routes that the vehicle may select in relation to an obstacle in front of the vehicle. The route distribution 705 may be a distribution of routes that the vehicle may select when an obstacle enters from the rear of the vehicle. The route distributions 701, 703, and 705 may be route distributions in which an operating range for a steering angle is small and an operating range for a longitudinal acceleration is large.

According to an embodiment, route distributions 711, 713, and 715 may be route distributions corresponding to a third maneuver mode for stopping the vehicle. The route distributions 711, 713, and 715 may represent distributions of routes that the vehicle may select when an obstacle exists not only in front of the vehicle but also behind the vehicle and may be generated to have a very small operating range for a longitudinal acceleration. When a driving route of the vehicle is determined according to the route distributions 711, 713, and 715, the vehicle may be controlled to stop.

According to an embodiment, route distributions 721, 723, and 725 may be route distributions corresponding to a fourth maneuver mode for swerving from obstacles around the vehicle. The route distributions 721, 723, and 725 may have a very large operating range for a steering angle and a longitudinal acceleration to swerve from the obstacles in front of the vehicle.

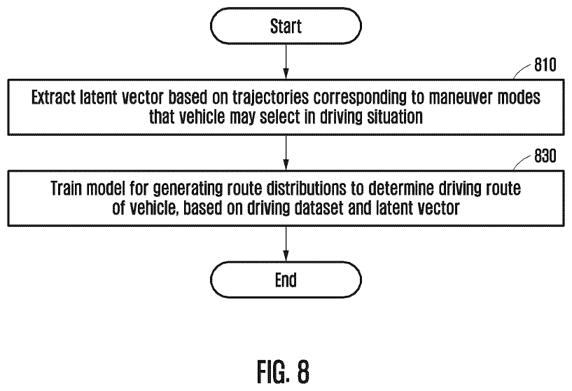

FIG. 8 is a flowchart illustrating a method of determining a driving route of a vehicle, according to an embodiment.

Referring to FIG. 8, according to an embodiment, operations 810 and 830 may be substantially the same as the method performed by a device (e.g., the vehicle control device 300 of FIG. 3) described above with reference to FIGS. 1 to 7C.

In operation 810, the vehicle control device 300 may extract a latent vector based on trajectories corresponding to maneuver modes that a vehicle may select in a driving situation. The trajectories may be generated by applying, to a route search algorithm, weights of indicators for maneuvers differently according to the maneuver modes.

In operation 830, the vehicle control device 300 may train a model for generating route distributions to determine a driving route of the vehicle, based on a driving dataset and the latent vector. Operation 830 may be substantially the same as the training of the model performed by the vehicle control device 300 described above with reference to FIG. 6A.

Operations 810 and 830 may be performed sequentially but are not limited thereto. For example, the operations may be performed in parallel.

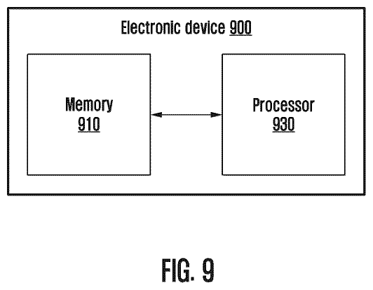

FIG. 9 is a schematic block diagram illustrating an electronic device according to an embodiment.

Referring to FIG. 9, according to an embodiment, an electronic device 900 (e.g., the vehicle control device 300 of FIG. 3) may include a memory 910 and a processor 930.

The memory 910 may store instructions (or programs) executable by the processor 930. For example, the instructions may include instructions for performing an operation of the processor 930 and/or an operation of each component of the processor 930.

The memory 910 may include one or more computer-readable storage media. The memory 910 may include non-volatile storage elements (e.g., a magnetic hard disc, an optical disc, a floppy disc, flash memory, electrically programmable read-only memory (EPROM), and electrically erasable and programmable read-only memory (EEPROM)).

The memory 910 may be a non-transitory medium. The term “non-transitory” may indicate that a storage medium is not embodied in a carrier wave or a propagated signal. However, the term “non-transitory” should not be interpreted to mean that the memory 910 is non-movable.

The processor 930 may process data stored in the memory 910. The processor 930 may execute computer-readable code (e.g., software) stored in the memory 910 and instructions triggered by the processor 930.

The processor 930 may be a data-processing device implemented by hardware having a circuit with a physical structure to execute desired operations. The desired operations may include, for example, code or instructions included in a program.

The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The processor 910 may cause the electronic device 900 to perform one or more operations by executing code and/or instructions stored in the memory 930. The operations performed by the electronic device 900 may be substantially the same as the operations performed by the vehicle control device 300 described above with reference to FIGS. 1 to 8. Accordingly, a repeated description thereof is omitted.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Accordingly, other implementations are within the scope of the following claims.

What is claimed is:

1. A method of training a model for determining a driving route of a vehicle, the method comprising:
extracting a latent vector based on trajectories corresponding to maneuver modes that the vehicle is capable of selecting in a driving situation; and
training the model for generating route distributions to determine the driving route of the vehicle, based on a driving dataset and the latent vector,
wherein the trajectories are generated by applying, to a route search algorithm, weights of indicators for maneuvers differently according to the maneuver modes.

2. The method of claim 1, wherein the indicators comprise a first indicator for a search time, a second indicator for a reference velocity, a third indicator for a lateral movement, a fourth indicator for a longitudinal movement, and a fifth indicator for a heading angle.

3. The method of claim 1, wherein the driving dataset comprises a velocity of the vehicle, map information, and occupancy information of obstacles around the vehicle.

4. The method of claim 1, wherein the maneuver modes comprise a first maneuver mode for keeping a lane, a second maneuver mode for changing a lane, a third maneuver mode for stopping the vehicle, a fourth maneuver mode for swerving from obstacles around the vehicle, and a fifth maneuver mode for following trajectories of obstacles around the vehicle.

5. The method of claim 1, wherein the trajectories are generated by applying, to the route search algorithm, an operating range corresponding to each of the maneuver modes.

6. The method of claim 5, wherein the operating range comprises an operating range for at least one of a steering angle and a longitudinal acceleration.

7. The method of claim 1, wherein the weights are determined based on one or more of the maneuver modes and information about the driving situation.

8. The method of claim 7, wherein the information about the driving situation comprises lane information and information about obstacles around the vehicle.

9. The method of claim 1, wherein the route search algorithm comprises a hybrid A* algorithm.

10. The method of claim 1, further comprising:
obtaining a route distribution by inputting the driving dataset to the trained model; and
controlling driving of the vehicle based on the route distribution.

11. An apparatus for training a model, the apparatus comprising:
a memory configured to store instructions; and
a processor electrically connected to the memory and configured to execute the instructions,
wherein, when the instructions are executed by the processor, the processor is configured to control a plurality of operations, and
wherein the plurality of operations comprises:
extracting a latent vector based on trajectories corresponding to maneuver modes that a vehicle is capable of selecting in a driving situation; and
training the model for generating route distributions to determine a driving route of the vehicle, based on a driving dataset and the latent vector,
wherein the trajectories are generated by applying, to a route search algorithm, weights of indicators for maneuvers differently according to the maneuver modes.

12. The apparatus of claim 11, wherein the indicators comprise a first indicator for a search time, a second indicator for a reference velocity, a third indicator for a lateral movement, a fourth indicator for a longitudinal movement, and a fifth indicator for a heading angle.

13. The apparatus of claim 11, wherein the driving dataset comprises a velocity of the vehicle, map information, and occupancy information of obstacles around the vehicle.

14. The apparatus of claim 11, wherein the maneuver modes comprise a first maneuver mode for keeping a lane, a second maneuver mode for changing a lane, a third maneuver mode for stopping the vehicle, a fourth maneuver mode for swerving from obstacles around the vehicle, and a fifth maneuver mode for following trajectories of the obstacles around the vehicle.

15. The apparatus of claim 11, wherein the trajectories are generated by applying, to the route search algorithm, an operating range corresponding to each of the maneuver modes.

16. The apparatus of claim 15, wherein the operating range comprises an operating range for at least one of a steering angle and a longitudinal acceleration.

17. The apparatus of claim 11, wherein the weights are determined based on one or more of the maneuver modes and information about the driving situation.

18. The apparatus of claim 17, wherein the information about the driving situation comprises lane information and information about obstacles around the vehicle.

19. The apparatus of claim 11, wherein the route search algorithm comprises a hybrid A* algorithm.

20. The apparatus of claim 11, wherein the plurality of operations further comprises:
obtaining a route distribution by inputting the driving dataset to the trained model; and
controlling driving of the vehicle based on the route distribution.
